(19) United States
(12) Patent Application Publication
(10) Pub. No.: US 2025/0029090 A1
(43) Pub. Date: Jan. 23, 2025

(54) System, Method, and Computer Program Product for Real-Time Transactions

(71) Applicant: Visa International Service Association, San Francisco, CA (US)

(72) Inventors: Pragathi M S, Bangalore (IN); Amit Kumar Mishra, Bangalore (IN)

(21) Appl. No.: 18/701,667

(22) PCT Filed: Oct. 21, 2021
(86) PCT No.: PCT/US2021/055969

§ 371 Date: Apr. 16, 2024

(51) Int. Cl. G06Q 20/32; G06Q 20/38

(52) U.S. Cl. CPC G06Q 20/326; G06Q 20/385; G06Q 20/388

(57) ABSTRACT

Described are a system, method, and computer program product for real-time transactions. The method includes receiving a real-time payment identifier request, the real-time payment identifier request including at least one of a phone number associated with the user device and an account identifier. The real-time payment identifier request may be communicated to a real-time payment platform located remotely from the user device. A real-time payment identifier may be received and stored in a real-time payment identifier database stored on the user device. A first transaction identifier request may be received from a first merchant system. The real-time payment identifier may be communicated to the first merchant system. A second transaction identifier request may be received from a second merchant system and the real-time payment identifier may be communicated to the second merchant system.

### CROSS-REFERENCE TO RELATED APPLICATION

This application is the United States national phase of International Patent Application No. PCT/US2021/055969 filed Oct. 21, 2021, the disclosure of which is hereby incorporated by reference in its entirety.

### BACKGROUND

### 1. Technical Field

Disclosed embodiments or aspects relate generally to real-time transactions and, in particular embodiments or aspects, to a system, method, and computer program product for conducting real-time transactions with a real-time payment identifier stored on the user device.

### 2. Technical Considerations

The use of real-time transactions has been increasing across the globe. These real-time transactions often rely on account alias addresses. However, these addresses are currently generated on the application level. A single user using the same financial account may have multiple account alias addresses for each of the merchants in which they have transactions. This results in a large number of account alias addresses being maintained by a large number of merchant systems for the same user. There exists a need to reduce the number of account alias addresses associated with a single user to reduce computing resources required of merchant systems.

### SUMMARY

According to non-limiting embodiments or aspects, provided is a method for real-time transactions. The method includes receiving, by a real-time payment application stored on a user device, a real-time payment identifier request, the real-time payment identifier request comprising at least one of a phone number associated with the user device and an account identifier; communicating, by the real-time payment application, the real-time payment identifier request to a real-time payment platform located remotely from the user device; receiving, by the real-time payment application, a real-time payment identifier generated by the real-time payment platform based on the real-time payment identifier request; storing, by the real-time application, the real-time payment identifier in a real-time payment identifier database, wherein the a real-time payment identifier database is stored on the user device; receiving, by the real-time payment application, a first transaction identifier request associated with at least one of the phone number and a user account identifier from a first merchant system; communicating, by the real-time payment application, the real-time payment identifier to the first merchant system in response to receiving the first transaction identifier request; receiving, by the real-time payment application, a second transaction identifier request associated with at least one of the phone number and the account identifier from a second merchant system; and communicating, by the real-time payment application, the real-time payment identifier to the second merchant system in response to receiving the second transaction identifier request.

In non-limiting embodiments or aspects, the method further includes: receiving, by the real-time payment application, a second real-time payment identifier request, the second real-time payment identifier request comprising a second account identifier; communicating, by the real-time payment application, the second real-time payment identifier request to the real-time payment platform located remotely from the user device; receiving, by the real-time payment application, a second real-time payment identifier generated by the real-time payment platform based on the real-time payment identifier request; and storing, by the real-time application, the second real-time payment identifier on the user device.

In non-limiting embodiments or aspects, the real-time payment identifier request may be received from a user through the real-time application stored on the user device. The first transaction identifier request may be received from a second application stored on the user device. Receiving, by the real-time payment application, the first transaction identifier request occurs before the real-time payment identifier request is received by the real-time payment application, wherein the method further includes determining, by the real-time payment application, no real-time payment identifier has been previously received or associated with at least one of the phone number associated with the user device and the account identifier; and communicating, by the real-time payment application, a real-time payment identifier initiation notification to the user device in response to determining no real-time payment identifier has been previously received, wherein the real-time payment identifier initiation notification directs the user to communicate the real-time payment identifier request to the real-time payment application.

In non-limiting embodiments or aspects, the method further includes: in response to receiving the first transaction identifier request, communicating, by the real-time payment application, a one-time password to the user device; receiving, by the real-time payment application, the one-time password from first merchant system; matching, by the real-time payment application, the one-time password received from the first merchant system to the one-time password communicated to the user device; and communicating, by the real-time payment application, the real-time payment identifier to the first merchant system in response to matching the one-time password. The real-time payment identifier request may be initiated during an initial setup process of the user device.

According to non-limiting embodiments or aspects, provided is a computer program product for real-time transactions, including at least one non-transitory computer readable medium including program instructions that, when executed by at least one processor, cause the at least one processor to: receive a real-time payment identifier request, the real-time payment identifier request comprising at least one of a phone number associated with the user device and an account identifier; communicate the real-time payment identifier request to a real-time payment platform located remotely from the user device; receive a real-time payment identifier generated by the real-time payment platform based on the real-time payment identifier request; store the real-time payment identifier in a real-time payment identifier database, wherein the a real-time payment identifier database is stored on the user device; receive a first transaction identifier request associated with at least one of the phone number and a user account identifier from a first merchant system; communicate the real-time payment identifier to the first merchant system in response to receiving the first transaction identifier request; receive a second transaction identifier request associated with at least one of the phone number and the account identifier from a second merchant system; and communicate the real-time payment identifier to the second merchant system in response to receiving the second transaction identifier request.

In non-limiting embodiments or aspects, the program instructions further cause the at least one processor to: receive a second real-time payment identifier request, the second real-time payment identifier request comprising a second account identifier; communicate the second real-time payment identifier request to the real-time payment platform located remotely from the user device; receive a second real-time payment identifier generated by the real-time payment platform based on the real-time payment identifier request; and store the second real-time payment identifier on the user device.

In non-limiting embodiments or aspects, the real-time payment identifier request is received from a user through the real-time application stored on the user device. The first transaction identifier request may be received from a second application stored on the user device. Receiving the first transaction identifier request occurs before the real-time payment identifier request is received, wherein the program instructions further cause the at least one processor to: determine no real-time payment identifier has been previously received associated with at least one of the phone number associated with the user device and the account identifier; and communicate a real-time payment identifier initiation notification to the user device in response to determining no real-time payment identifier has been previously received, wherein the real-time payment identifier initiation notification directs the user to communicate the real-time payment identifier request to the real-time payment application.

In non-limiting embodiments or aspects, the program instructions further cause the at least one processor to: in response to receiving the first transaction identifier request, communicate a one-time password to the user device; receive the one-time password from first merchant system; match the one-time password received from the first merchant system to the one-time password communicated to the user device; and communicate the real-time payment identifier to the first merchant system in response to matching the one-time password. The real-time payment identifier request may be initiated during an initial setup process of the user device.

According to non-limiting embodiments or aspects, provided is a system for real-time transactions, including at least one real-time payment application including at least one processor programmed or configured to: receive a real-time payment identifier request, the real-time payment identifier request comprising at least one of a phone number associated with the user device and an account identifier; communicate the real-time payment identifier request to a real-time payment platform located remotely from the user device; receive a real-time payment identifier generated by the real-time payment platform based on the real-time payment identifier request; store the real-time payment identifier in a real-time payment identifier database, wherein the a real-time payment identifier database is stored on the user device; receive a first transaction identifier request associated with at least one of the phone number and a user account identifier from a first merchant system; communicate the real-time payment identifier to the first merchant system in response to receiving the first transaction identifier request; receive a second transaction identifier request associated with at least one of the phone number and the account identifier from a second merchant system; and communicate the real-time payment identifier to the second merchant system in response to receiving the second transaction identifier request.

In non-limiting embodiments or aspects, the at least one processor is further programmed or configured to: receive a second real-time payment identifier request, the second real-time payment identifier request comprising a second account identifier; communicate the second real-time payment identifier request to the real-time payment platform located remotely from the user device; receive a second real-time payment identifier generated by the real-time payment platform based on the real-time payment identifier request; and store the second real-time payment identifier on the user device. The real-time payment identifier request may be received from a user through the real-time application stored on the user device. The first transaction identifier request may be received from a second application stored on the user device.

In non-limiting embodiments or aspects, receiving the first transaction identifier request occurs before the real-time payment identifier request is received, wherein the at least one processor is further programmed or configured to: determine no real-time payment identifier has been previously received associated with at least one of the phone number associated with the user device and the account identifier; and communicate a real-time payment identifier initiation notification to the user device in response to determining no real-time payment identifier has been previously received, wherein the real-time payment identifier initiation notification directs the user to communicate the real-time payment identifier request to the real-time payment application.

In non-limiting embodiments or aspects, the at least one processor is further programmed or configured to: in response to receiving the first transaction identifier request, communicate a one-time password to the user device; receive the one-time password from first merchant system; match the one-time password received from the first merchant system to the one-time password communicated to the user device; and communicate the real-time payment identifier to the first merchant system in response to matching the one-time password. The real-time payment identifier request may be initiated during an initial setup process of the user device.

Further non-limiting embodiments or aspects will be set forth in the following numbered clauses:

Clause 1: A method comprising: receiving, by a real-time payment application stored on a user device, a real-time payment identifier request, the real-time payment identifier request comprising at least one of a phone number associated with the user device and an account identifier; communicating, by the real-time payment application, the real-time payment identifier request to a real-time payment platform located remotely from the user device; receiving, by the real-time payment application, a real-time payment identifier generated by the real-time payment platform based on the real-time payment identifier request; storing, by the real-time application, the real-time payment identifier in a real-time payment identifier database, wherein the a real-time payment identifier database is stored on the user device; receiving, by the real-time payment application, a first transaction identifier request associated with at least one of the phone number and a user account identifier from a first merchant system; communicating, by the real-time payment application, the real-time payment identifier to the first merchant system in response to receiving the first transaction identifier request; receiving, by the real-time payment application, a second transaction identifier request associated with at least one of the phone number and the account identifier from a second merchant system; and communicating, by the real-time payment application, the real-time payment identifier to the second merchant system in response to receiving the second transaction identifier request.

Clause 2: The method of clause 1, wherein the method further comprises: receiving, by the real-time payment application, a second real-time payment identifier request, the second real-time payment identifier request comprising a second account identifier; communicating, by the real-time payment application, the second real-time payment identifier request to the real-time payment platform located remotely from the user device; receiving, by the real-time payment application, a second real-time payment identifier generated by the real-time payment platform based on the real-time payment identifier request; and storing, by the real-time application, the second real-time payment identifier on the user device.

Clause 3: The method of clauses 1 or 2, wherein the real-time payment identifier request is received from a user through the real-time application stored on the user device.

Clause 4: The method of any of clauses 1-3, wherein the first transaction identifier request is received from a second application stored on the user device.

Clause 5: The method of any of clauses 1-4, wherein receiving, by the real-time payment application, the first transaction identifier request occurs before the real-time payment identifier request is received by the real-time payment application, wherein the method further comprises: determining, by the real-time payment application, no real-time payment identifier has been previously received associated with at least one of the phone number associated with the user device and the account identifier; and communicating, by the real-time payment application, a real-time payment identifier initiation notification to the user device in response to determining no real-time payment identifier has been previously received, wherein the real-time payment identifier initiation notification directs the user to communicate the real-time payment identifier request to the real-time payment application.

Clause 6: The method of any of clauses 1-5, wherein the method further comprises: in response to receiving the first transaction identifier request, communicating, by the real-time payment application, a one-time password to the user device; receiving, by the real-time payment application, the one-time password from first merchant system; matching, by the real-time payment application, the one-time password received from the first merchant system to the one-time password communicated to the user device; and communicating, by the real-time payment application, the real-time payment identifier to the first merchant system in response to matching the one-time password.

Clause 7: The method of any of clauses 1-6, wherein the real-time payment identifier request is initiated during an initial setup process of the user device.

Clause 8: A computer program product for real-time transactions, comprising at least one non-transitory computer readable medium including program instructions that, when executed by at least one processor, cause the at least one processor to: receive a real-time payment identifier request, the real-time payment identifier request comprising at least one of a phone number associated with the user device and an account identifier; communicate the real-time payment identifier request to a real-time payment platform located remotely from the user device; receive a real-time payment identifier generated by the real-time payment platform based on the real-time payment identifier request; store the real-time payment identifier in a real-time payment identifier database, wherein the a real-time payment identifier database is stored on the user device; receive a first transaction identifier request associated with at least one of the phone number and a user account identifier from a first merchant system; communicate the real-time payment identifier to the first merchant system in response to receiving the first transaction identifier request; receive a second transaction identifier request associated with at least one of the phone number and the account identifier from a second merchant system; and communicate the real-time payment identifier to the second merchant system in response to receiving the second transaction identifier request.

Clause 9: The computer program product of clause 8, wherein the program instructions further cause the at least one processor to: receive a second real-time payment identifier request, the second real-time payment identifier request comprising a second account identifier; communicate the second real-time payment identifier request to the real-time payment platform located remotely from the user device; receive a second real-time payment identifier generated by the real-time payment platform based on the real-time payment identifier request; and store the second real-time payment identifier on the user device.

Clause 10: The computer program product of clauses 8 or 9, wherein the real-time payment identifier request is received from a user through the real-time application stored on the user device.

Clause 11: The computer program product of any of clauses 8-10, wherein the first transaction identifier request is received from a second application stored on the user device.

Clause 12: The computer program product of any of clauses 8-11, wherein receiving the first transaction identifier request occurs before the real-time payment identifier request is received, wherein the program instructions further cause the at least one processor to: determine no real-time payment identifier has been previously received associated with at least one of the phone number associated with the user device and the account identifier; and communicate a real-time payment identifier initiation notification to the user device in response to determining no real-time payment identifier has been previously received, wherein the real-time payment identifier initiation notification directs the user to communicate the real-time payment identifier request to the real-time payment application.

Clause 13: The computer program product of any of clauses 8-12, wherein the program instructions further cause the at least one processor to: in response to receiving the first transaction identifier request, communicate a one-time password to the user device; receive the one-time password from first merchant system; match the one-time password received from the first merchant system to the one-time password communicated to the user device; and communicate the real-time payment identifier to the first merchant system in response to matching the one-time password.

Clause 14: The computer program product of any of clauses 8-13, wherein the real-time payment identifier request is initiated during an initial setup process of the user device.

Clause 15: A system for real-time transactions, comprising at least one real-time payment application including at least one processor programmed or configured to: receive a real-time payment identifier request, the real-time payment identifier request comprising at least one of a phone number associated with the user device and an account identifier; communicate the real-time payment identifier request to a real-time payment platform located remotely from the user device; receive a real-time payment identifier generated by the real-time payment platform based on the real-time payment identifier request; store the real-time payment identifier in a real-time payment identifier database, wherein the a real-time payment identifier database is stored on the user device; receive a first transaction identifier request associated with at least one of the phone number and a user account identifier from a first merchant system; communicate the real-time payment identifier to the first merchant system in response to receiving the first transaction identifier request; receive a second transaction identifier request associated with at least one of the phone number and the account identifier from a second merchant system; and communicate the real-time payment identifier to the second merchant system in response to receiving the second transaction identifier request.

Clause 16: The system of clause 15, wherein the at least one processor is further programmed or configured to: receive a second real-time payment identifier request, the second real-time payment identifier request comprising a second account identifier; communicate the second real-time payment identifier request to the real-time payment platform located remotely from the user device; receive a second real-time payment identifier generated by the real-time payment platform based on the real-time payment identifier request; and store the second real-time payment identifier on the user device.

Clause 17: The system of clauses 15 or 16, wherein the real-time payment identifier request is received from a user through the real-time application stored on the user device.

Clause 18: The system of any of clauses 15-17, wherein the first transaction identifier request is received from a second application stored on the user device.

Clause 19: The system of any of clauses 15-18, wherein receiving the first transaction identifier request occurs before the real-time payment identifier request is received, wherein the at least one processor is further programmed or configured to: determine no real-time payment identifier has been previously received associated with at least one of the phone number associated with the user device and the account identifier; and communicate a real-time payment identifier initiation notification to the user device in response to determining no real-time payment identifier has been previously received, wherein the real-time payment identifier initiation notification directs the user to communicate the real-time payment identifier request to the real-time payment application.

Clause 20: The system of any of clauses 15-19, wherein the at least one processor is further programmed or configured to: in response to receiving the first transaction identifier request, communicate a one-time password to the user device; receive the one-time password from first merchant system; match the one-time password received from the first merchant system to the one-time password communicated to the user device; and communicate the real-time payment identifier to the first merchant system in response to matching the one-time password.

Clause 21: The system of any of clauses 15-20, wherein the real-time payment identifier request is initiated during an initial setup process of the user device.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1 is a schematic diagram of a system for real-time transactions according to non-limiting embodiments or aspects;

FIG. 2 shows example components of a computing device for implementing and performing the systems and methods described herein according to non-limiting embodiments or aspects;

FIG. 3 is a flow diagram of an enrollment process for enrolling in the real-time payment system according to non-limiting embodiments or aspects; and

FIG. 4 is a flow diagram of a process of making a real-time payment transaction according to non-limiting embodiments or aspects;

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments or aspects as they are oriented in the drawing figures. However, it is to be understood that the embodiments or aspects may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet, and/or the like) that includes data. Any known electronic communication protocols and/or algorithms may be used such as, for example, TCP/IP (including HTTP and other protocols), WLAN (including 802.11 and other radio frequency-based protocols and methods), analog transmissions, cellular networks (e.g., Global System for Mobile Communications (GSM), Code Division Multiple Access (CDMA), Long-Term Evolution (LTE), Worldwide Interoperability for Microwave Access (WiMAX®), etc.), and/or the like. It will be appreciated that numerous other arrangements are possible.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices.

As used herein, the term “computing device” may refer to one or more electronic devices that are configured to process data. The computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

Non-limiting embodiments or aspects are directed to a system, method, and computer program product for real-time transactions. In non-limiting embodiments or aspects, the use of computer processing resources is made more efficient (e.g., reduced usage of resources) by reducing the number of third parties that must generate and store real-time payment identifiers. These features and others also reduce the total number of real-time payment identifiers. Instead of a single user with a single account identifier being associated with dozens of real-time payment identifiers for dozens of merchants, non-limiting embodiments or aspects make it possible for the single user to utilize a single real-time payment identifier across all merchants. This also increases security as it reduces the number of identifiers that could be compromised. Instead of each merchant being required to maintain security resources for ensuring the real-time payment identifiers for all clients of the merchant are protected, the real-time payment system can secure the security resources necessary for protecting the same number of clients for a significantly smaller number of real-time payment identifiers resulting in significantly less total security resources being utilized.

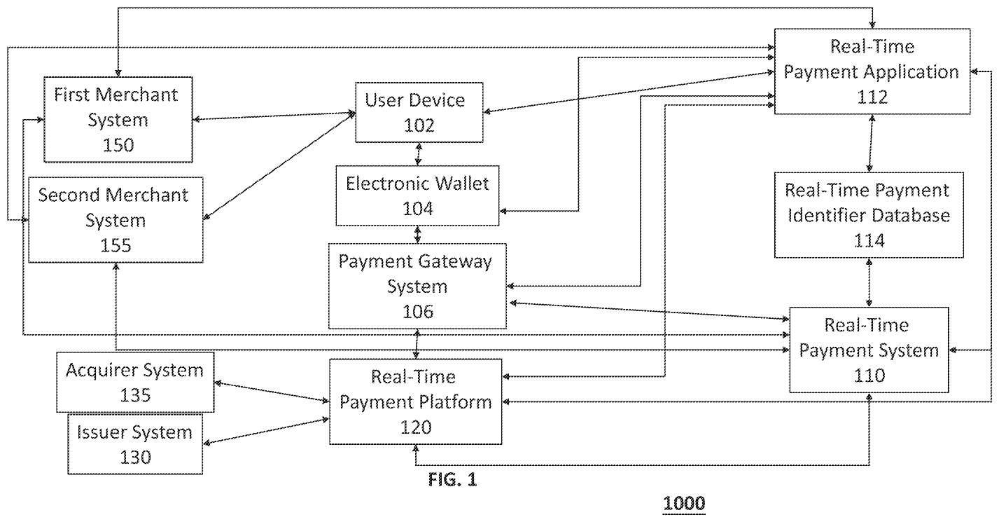

Referring now to FIG. 1, shown is a schematic diagram for a system 1000 for real-time transactions, according to non-limiting embodiments or aspects. The system 1000 includes a user device 102, an electronic wallet 104, a payment gateway system 106, a real-time payment system 110, a real-time payment application 112, a real-time payment identifier database 114, a real-time payment platform 120, and issuer system 130, an acquirer system 135, a first merchant system 150, and a second merchant system 155. As used herein, the terms “real-time payment” (RTP) and “real-time transaction” refer to a payment transaction that is initiated and settled instantly or near instantly (e.g., such that the payee receives funds from a payor within seconds of the payment being initiated, including but not limited to a peer-to-peer payment and/or the like). For example, a real-time transaction may be completed (e.g., settled) while a payor and payee interact, within several seconds of such an interaction, and/or the like. The real-time payment system may include a platform for making such instant or near-instant settlements.

With continued reference to FIG. 1, according to non-limiting embodiments or aspects, a user may desire to have a single payment identifier associated with their phone number and/or account identifier. The user may be associated with a user device 102. The user device 102 may be a mobile device and may be associated with a phone number and/or a user device identifier. The user and/or user device 102 may be associated with one or more account identifiers issued by an issuer associated with the issuer system 130. The user may intend to utilize real-time payments to make a transaction with a merchant, such as through a website or a mobile application. Prior to completing a transaction with the merchant, the user may register their phone number, user device identifier, and/or account identifier with the real-time payment system 110 in order to associate the user device 102 with a real-time payment identifier. The real-time payment system 110 may include a real-time payment application 112 and a real-time payment identifier database 114. The real-time payment system 110 may be associated with more than one real-time payment application 112 and real-time payment identifier database 114 associated with more than one user device 102. The real-time payment identifier may be alphanumeric or any combination of characters and/or symbols, and may be in the form of a payment token that is used for a real-time payment. The real-time payment identifier may be associated with an account identifier such that a user may use the real-time payment identifier in a transaction with a merchant instead of (e.g., in place of) the account identifier, allowing the transaction to be charged to the account associated with the account identifier without providing the account identifier to the merchant, reducing the potential for fraud.

With continued reference to FIG. 1, in non-limiting embodiments or aspects, registration with a real-time payment system 110 may occur during an initial setup process of the user device 102. The real-time payment system 110 may include a real-time payment application 112 that is factory installed on the user device 102, or may be a real-time payment application 112 that must be downloaded to the user device 102, such as through an application store. The initial setup process may occur the first time a user is accessing the user device 102, or the first use after the user device 102 has undergone a factory reset. When a user begins the process of setting up the user device 102, such as a mobile device, the user interface (UI) of the user device 102 may prompt the user to register the user device 102 with a real-time payment system 110. The prompt may allow the user to accept or decline the prompt. In non-limiting embodiments or aspects, the real-time payment system 110 may be hosted and/or operated by a manufacturer of the user device 102 and/or an operating system installed on the user device 102. In other examples, the real-time payment system 110 may be hosted and/or operated independent of a manufacturer of the user device 102 or an operating system thereof.

With continued reference to FIG. 1, in non-limiting embodiments or aspects, if the user accepts the prompt, a real-time payment identifier request may be initiated. The real-time payment identifier request may alert the real-time payment system 110 that the user wishes to obtain a real-time payment identifier. The user may be prompted through the user device 102 to register with the real-time payment system 110. The registration process may occur through a real-time payment application 112. The real-time payment application may be stored on the user device 102. The user may communicate the real-time payment identifier request to the real-time payment system 110 through the real-time payment application 112.

With continued reference to FIG. 1, in non-limiting embodiments or aspects, the user may communicate more than one real-time payment identifier requests. Additional real-time payment identifier requests may be associated with different account identifiers. Each account identifier associated with the user may be associated with a different real-time payment identifier.

With continued reference to FIG. 1, in non-limiting embodiments or aspects, the real-time payment identifier request may include the phone number associated with the user device 102 and/or the account identifier associated with a financial account of the user to the real-time payment system 110. For example, the user may enter the phone number and/or account identifier into a UI displayed on the user device 102 from the real-time payment application 112.

With continued reference to FIG. 1, in non-limiting embodiments or aspects, instead of registering with the real-time payment system 110 during the phone setup process, the user may instead register with the real-time payment system 110 through the real-time payment application 112 stored on the user device 102. The user may select the real-time payment application 112 on their user device 102 through the UI of the user device 102. The user may then select to register with the real-time payment system 110 through the UI on the user device 102.

With continued reference to FIG. 1, in non-limiting embodiments or aspects, the user may initiate registering with the real-time payment system 110 through a third-party application, such as an electronic wallet 104 or a merchant application on the user device 102. A user may select to register an account identifier associated with the third-party application with the real-time payment system 110. The third-party application may communicate the real-time payment identifier request to the real-time payment system 110, including the account identifier associated with the user. In some examples, an electronic wallet 104 may automatically generate a real-time payment identifier request based on information previously stored with the electronic wallet 104, such as an account identifier and/or phone number.

With continued reference to FIG. 1, in non-limiting embodiments or aspects, the user may initiate a transaction or register a payment method with a merchant, such as through a merchant's website and/or mobile application. When prompted to select the method of payment, the user may select to pay through a real-time payment identifier. If the user does not have a real-time payment identifier associated with their user device 102, mobile phone number, and/or account identifier, the user may be prompted to initiate registration with the real-time payment system 110 in order to obtain a real-time payment identifier to complete the transaction. For example, the merchant's website and/or mobile application may redirect the user device 102 to a website and/or mobile application for initiating registration.

With continued reference to FIG. 1, in non-limiting embodiments or aspects, when the real-time payment system 110 receives the real-time payment identifier request, the real-time payment system 110 may communicate the request to a real-time payment platform 120. In some non-limiting embodiments or aspects, the real-time payment identifier request may be communicated to the real-time payment platform 120 through a payment gateway system 106. The real-time payment platform 120 may include one or more computing devices, such as a server computer.

With continued reference to FIG. 1, in non-limiting embodiments or aspects, the real-time payment platform 120 may be remote from the user device 102. In response to receiving the real-time payment identifier request, the real-time payment platform 120 may automatically generate a real-time payment identifier. The real-time payment identifier may be generated based on the real-time payment identifier request, such as the phone number and/or the account identifier associated with the real-time payment identifier request. For example, the real-time payment identifier may be generated by hashing the phone number and/or the account identifier, inputting the phone number and/or account identifier into a token generation algorithm, associating a random or pseudo-random value with the phone number and/or account identifier in a database, and/or the like. The real-time payment platform 120 may communicate the real-time payment identifier to the real-time payment application 112. For example, the real-time payment platform 120 may communicate the real-time payment identifier to the real-time payment application 112 through the real-time payment system 110.

With continued reference to FIG. 1, in non-limiting embodiments or aspects, in response to receiving the real-time payment identifier, the real-time payment application 112 may store the real-time payment identifier in a real-time payment identifier database 114. The real-time payment identifier database 114 may be stored on the user device 102. The real-time payment identifier database 114 may map real-time payment identifiers to corresponding account identifiers and/or phone numbers. The real-time payment identifier database 114 may also map the real-time payment identifiers to a company name associated with the corresponding account identifier. The real-time payment identifier database 114 may also map the real-time payment identifiers to the device identifier associated with the user device 102. The real-time payment identifier database 114 may store multiple real-time payment identifiers associated with the same user device 102 and/or phone number, each real-time account identifier being associated with a different account identifier. In non-limiting embodiments or aspects, there may be multiple real-time payment identifiers associated with a single account identifier where each of the multiple real-time payment identifiers are associated with different merchants.

With continued reference to FIG. 1, in non-limiting embodiments or aspects, a user may initiate a transaction with a first merchant system 150. The user may initiate the transaction with the first merchant system 150 through the user device 102. The user device 102 may access the merchant system 150 through an application stored on the user device 102 and/or through a website. The user may select a payment option for the transaction, such as a selectable payment option presented on a checkout page. The user may select a real-time payment method for payment. If more than one real-time payment identifier is associated with the user, user device 102, and/or phone number, the user may select which real-time payment identifier to apply toward the transaction. The user may select which real-time payment identifier to apply by selecting a reference name (e.g., nickname, bank name, account name, etc.) associated with the real-time payment identifier. The selectable payment option may be presented through the merchant application and/or website, through a web plug-in, through a separate mobile application and/or website embedded in or presented via the merchant application and/or website, or the like.

With continued reference to FIG. 1, in non-limiting embodiments or aspects, in response to receiving a transaction request including a real-time payment method for payment, the first merchant system 150 may communicate a transaction identifier request associated with the transaction request to the real-time payment system 110 or real-time payment application 112. The transaction identifier request may include, for example, one or more data structures arranged for communication via one or more data packets. For example, the transaction identifier request may be in the form of a message with predefined fields. The transaction identifier request may be communicated to the application associated with the first merchant system 150 stored on the user device 102. The transaction identifier request may be associated with the phone number and/or the account identifier. For example, the transaction request may include the phone number and/or user device identifier associated with the user device 102. The user device identifier may be an alphanumeric code or any combination of characters and/or symbols associated with the user device 102. The transaction identifier request may include the reference name associated with the real-time payment identifier or account identifier. The first merchant system 150 may communicate with the real-time payment system 110 or real-time application 112 through one or more APIs. The APIs may query the real-time payment identifier associated with the account identifiers. The APIs may be made available to any application and/or approved applications configured to process transactions with real-time payment identifiers.

With continued reference to FIG. 1, in non-limiting embodiments or aspects, in response to receiving the transaction identifier request, the real-time payment system 110 may communicate the transaction identifier request to the real-time payment application 112.

With continued reference to FIG. 1, in non-limiting embodiments or aspects, in response to receiving the transaction identifier request, the real-time payment application 112 may initiate a one-time password (OTP) associated with the transaction identifier request. The real-time payment application 112 may communicate the OTP to the user device 102 associated with the transaction identifier request. The OTP may be communicated to the user device 102 through an application on the user device 102, a text message, and/or the like. The user may then be directed to communicate the OTP to the first merchant system 150.

With continued reference to FIG. 1, in non-limiting embodiments or aspects, in response to receiving the transaction identifier request, the real-time payment application 112 may retrieve the real-time payment identifier associated with the account identifier, user device identifier, and/or the phone number from the real-time payment identifier database 114. The real-time payment application 112 may search the real-time payment identifier database 114 based on the phone number, user device 102, reference name, and/or the like. The real-time payment application 112 may communicate the retrieved real-time payment identifier to the first merchant system 150. The communication of the real-time payment identifier may be in response to receiving the transaction identifier request. The OTP may be communicated to the first merchant system 150 through a mobile application, website, phone number (e.g., text message), email, and/or the like. The first merchant system 150 may then communicate the OTP received from the user device 102 to the real-time payment application 112. The OTP may be communicated with a transaction identifier request. The real-time payment application 112 may then compare the OTP received from the first merchant system 150 to the OTP communicated to the user device 102. If the real-time payment application 112 determines that the two OTPs match, then the real-time payment application 112 may automatically communicate the real-time payment identifier to the first merchant system in response to determining the match.

With continued reference to FIG. 1, in non-limiting embodiments or aspects, if the real-time payment application 112 is unable to retrieve the real-time payment identifier from the real-time payment identifier database 114 and/or it is determined that no associated real-time payment identifier associated with the transaction identifier request is in the real-time payment identifier database 114 (e.g., no real-time payment identifier was previously generated and/or received by the real-time payment application 112), the real-time payment application 112 may direct the user associated with the transaction identifier request to register with the real-time payment application 112. For example, the real-time payment application 112 may communicate a real-time payment identifier initiation notification to the user device 102 associated with the transaction identifier request. The real-time payment application 112 may communicate with the user device 102 through the phone number associated with the transaction identifier request. The real-time payment identifier initiation notification may direct the user through a UI to communicate a real-time payment identifier request to the real-time payment application 112. The real-time payment identifier initiation notification may include data associated with the first merchant system 150 and the transaction.

With continued reference to FIG. 1, in non-limiting embodiments or aspects, in response to receiving the real-time payment identifier, the first merchant system 150 may communicate a transaction request including the real-time payment identifier to the payment gateway system 106. The payment gateway system 106 may process the transaction request. The payment gateway system 106 may communicate the transaction request to the real-time payment platform 120.

With continued reference to FIG. 1, in non-limiting embodiments or aspects, in response to receiving the transaction request, the real-time payment platform 120 may automatically retrieve the account identifier associated with the real-time payment identifier associated with the transaction request. The real-time payment platform 120 may communicate the transaction request and the account identifier to an acquirer system 135. The acquirer system 135 may approve or reject the transaction request based on the account identifier. The acquirer system 135 may communicate the approval or rejection to the real-time payment platform 120.

With continued reference to FIG. 1, in non-limiting embodiments or aspects, in response to receiving the transaction request approval, the real-time payment platform 120 may automatically communicate the approval and the transaction request to an issuer system 130 associated with the account identifier. The issuer system 130 may process the transaction request. In response to communicating the transaction request to the issuer system 130, the real-time payment platform may automatically communicate confirmation of the completion of the transaction request to the first merchant system 150.

With continued reference to FIG. 1, in some non-limiting embodiments or aspects, the same real-time payment identifier may be used to process transactions from multiple merchant systems. For example, the user may initiate a second transaction with a second merchant system 155. For example, the second transaction may be initiated through an application associated with the second merchant system 155 or a website associated with the second merchant system 155. As with the transaction with the first merchant system 150, the second merchant system 155 may communicate a transaction identifier request to the real-time payment application 112. The transaction identifier request may be associated with the phone number associated with the user or user device 102 and/or may be associated with an account identifier associated with the user. The real-time payment application 112 may retrieve the real-time payment identifier from the real-time payment identifier database 114 based on the transaction identifier request.

With continued reference to FIG. 1, in some non-limiting embodiments or aspects, after retrieving the real-time payment identifier, the real-time payment application 112 may communicate the real-time payment identifier to the second merchant system 155. If the account identifier associated with the real-time payment identifier is the same account identifier associated with the real-time payment identifier communicated to the first merchant system 150, then the real-time payment identifier communicated to the second merchant system 155 will be the same real-time payment identifier as the one communicated to the first merchant system 150.

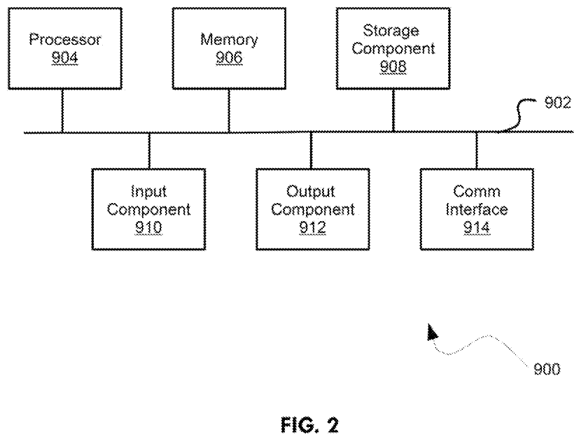

Referring now to FIG. 2, shown is a diagram of example components of a device 900 according to non-limiting embodiments or aspects. Device 900 may correspond to the user device 102, electronic wallet 104, payment gateway system 106, real-time payment system 110, real-time payment platform 120, issuer system 130, acquirer system 135, first merchant system 150, and second merchant system 155 in FIG. 1, as an example. In some non-limiting embodiments or aspects, such systems or devices may include at least one device 900 and/or at least one component of device 900. The number and arrangement of components shown are provided as an example. In some non-limiting embodiments or aspects, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 2, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

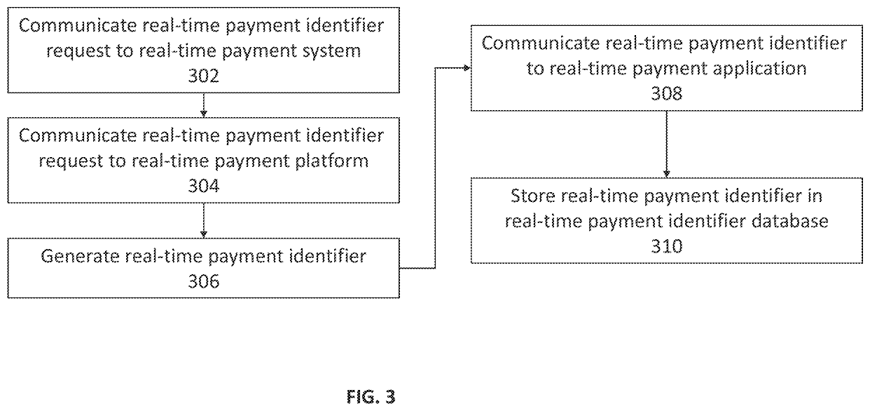

Referring now to FIG. 3, shown is a flow diagram of an enrollment process for enrolling in the real-time payment system in non-limiting embodiments or aspects. It will be appreciated that the steps shown in the flow diagram are for example purposes only and that additional, fewer, and/or different steps, and/or a different order of steps, may be implemented in non-limiting embodiments or aspects. In step 302, the user communicates a real-time payment identifier request to a real-time payment system. The real-time payment identifier request is a communication that alerts the real-time payment system that the user is interested in obtaining a real-time payment identifier. The real- time payment identifier request may include a user device identifier (e.g., an alphanumeric code or any combination of characters and/or symbols) associated with the user device associated with the user. The real-time payment identifier request may include an account identifier and/or a phone number associated with the user.

With continued reference to FIG. 3, in some non-limiting embodiments or aspects, in step 304, the real-time payment system may communicate the real-time payment identifier request to the real-time payment platform. The real-time payment identifier request may be communicated to the real-time payment platform directly or through the payment gateway system.

With continued reference to FIG. 3, in some non-limiting embodiments or aspects, in step 306, the real-time payment identifier is generated by the real-time payment platform. The real-time payment identifier may be alphanumeric or any combination of characters and/or symbols. The real-time payment identifier may be associated with a user device identifier, an account identifier of the user, a user phone number, and/or the like.

With continued reference to FIG. 3, in some non-limiting embodiments or aspects, in step 308, the real-time payment platform communicates the real-time payment identifier to the real-time payment application. The real-time payment identifier may be communicated directly to the real-time payment application or through the real-time payment system.

With continued reference to FIG. 3, in some non-limiting embodiments or aspects, in step 310, the real-time payment application may store the real-time payment identifier in a real-time payment identifier database. The real-time payment identifier database may be stored on the user device and may associate the real-time payment identifier with an account identifier, phone number, and/or user device identifier.

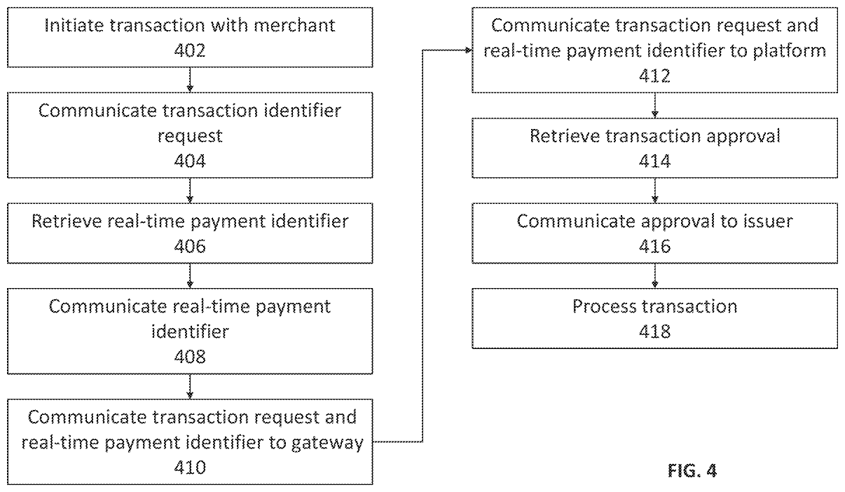

Referring now to FIG. 4, shown is a flow diagram of a process of making a real-time payment transaction according to non-limiting embodiments or aspects. It will be appreciated that the steps shown in the flow diagram are for example purposes only and that additional, fewer, and/or different steps, and/or a different order of steps, may be implemented in non-limiting embodiments or aspects. In step 402, a user initiates a transaction with a merchant. For example, the transaction may be initiated through a mobile application on the user device or through a website associated with the merchant. During the checkout of the transaction, the user may elect real-time payment as the method for payment for the transaction.

With continued reference to FIG. 4, in non-limiting embodiments or aspects, in step 404, the merchant may communicate a transaction identifier request to the real-time payment application. The transaction identifier request may indicate to the real-time payment application that the merchant is interested in receiving the real-time payment identifier associated with a user and/or user device for use in a transaction with the merchant. The transaction identifier request may be communicated directly to the real-time payment application or through the real-time payment system.

With continued reference to FIG. 4, in non-limiting embodiments or aspects, in step 406, the real-time payment application may retrieve the real-time payment identifier from the real-time payment identifier database. The real-time payment identifier may be stored on the user device. In step 408, the real-time payment application may communicate the real-time payment identifier to the merchant, either directly or through the real-time payment system.

With continued reference to FIG. 4, in non-limiting embodiments or aspects, in step 410, the merchant may communicate the transaction request with the real-time payment identifier to the payment gateway system.

With continued reference to FIG. 4, in non-limiting embodiments or aspects, in step 412, the payment gateway system may communicate the transaction request and the real-time payment identifier to the real-time payment platform. In step 414, the real-time payment platform may retrieve an approval of the transaction from the acquirer system. In step 416, the real-time payment platform may communicate the transaction approval to the issuer system. In step 418, the issuer system may process the transaction.

According to non-limiting embodiments or aspects, the following is an example use of a real-time payment identifier. A user may initiate a transaction with a merchant. During checkout, the user may select a method of payment. The user may desire to use a real-time payment identifier associated with their debit account at their bank. A real-time payment identifier may be stored on the user device associated with the user in a real-time payment identifier. The user may select the real-time payment as the method of payment for the transaction. The merchant system associated with the merchant may then retrieve the real-time payment identifier from the user device. The real-time payment identifier may be stored in a real-time payment identifier database. The merchant system may then communicate the real-time payment identifier in a transaction request to a payment gateway system for processing.

The user may then wish to make a second transaction with a second merchant. The user may wish to use the same debit account as the one used with the transaction with the first merchant. During checkout, the user may select the real-time payment identifier as the method of payment. The second merchant may retrieve the same real-time identifier for the transaction as was retrieved by the first merchant. The second merchant may then communicate the real-time payment identifier to a payment gateway system.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A method comprising:
receiving, by a real-time payment application stored on a user device, a real-time payment identifier request, the real-time payment identifier request comprising at least one of a phone number associated with the user device and an account identifier;
communicating, by the real-time payment application, the real-time payment identifier request to a real-time payment platform located remotely from the user device;
receiving, by the real-time payment application, a real-time payment identifier generated by the real-time payment platform based on the real-time payment identifier request;
storing, by the real-time payment application, the real-time payment identifier in a real-time payment identifier database, wherein the a real-time payment identifier database is stored on the user device;
receiving, by the real-time payment application, a first transaction identifier request associated with at least one of the phone number and a user account identifier from a first merchant system;
communicating, by the real-time payment application, the real-time payment identifier to the first merchant system in response to receiving the first transaction identifier request;
receiving, by the real-time payment application, a second transaction identifier request associated with at least one of the phone number and the account identifier from a second merchant system; and
communicating, by the real-time payment application, the real-time payment identifier to the second merchant system in response to receiving the second transaction identifier request.

2. The method of claim 1, wherein the method further comprises:
receiving, by the real-time payment application, a second real-time payment identifier request, the second real-time payment identifier request comprising a second account identifier;
communicating, by the real-time payment application, the second real-time payment identifier request to the real-time payment platform located remotely from the user device;
receiving, by the real-time payment application, a second real-time payment identifier generated by the real-time payment platform based on the real-time payment identifier request; and
storing, by the real-time payment application, the second real-time payment identifier on the user device.

3. The method of claim 1, wherein the real-time payment identifier request is received from a user through the real-time payment application stored on the user device.

4. The method of claim 1, wherein the first transaction identifier request is received from a second application stored on the user device.

5. The method of claim 1, wherein receiving, by the real-time payment application, the first transaction identifier request occurs before the real-time payment identifier request is received by the real-time payment application, wherein the method further comprises:
determining, by the real-time payment application, no real-time payment identifier has been previously received associated with at least one of the phone number associated with the user device and the account identifier; and
communicating, by the real-time payment application, a real-time payment identifier initiation notification to the user device in response to determining no real-time payment identifier has been previously received, wherein the real-time payment identifier initiation notification directs a user to communicate the real-time payment identifier request to the real-time payment application.

6. The method of claim 1, wherein the method further comprises:
in response to receiving the first transaction identifier request, communicating, by the real-time payment application, a one-time password to the user device;
receiving, by the real-time payment application, the one-time password from the first merchant system;
matching, by the real-time payment application, the one-time password received from the first merchant system to the one-time password communicated to the user device; and
communicating, by the real-time payment application, the real-time payment identifier to the first merchant system in response to matching the one-time password.

7. The method of claim 1, wherein the real-time payment identifier request is initiated during an initial setup process of the user device.

8. A computer program product for real-time transactions, comprising at least one non-transitory computer readable medium including program instructions that, when executed by at least one processor, cause the at least one processor to:
receive a real-time payment identifier request, the real-time payment identifier request comprising at least one of a phone number associated with a user device and an account identifier;
communicate the real-time payment identifier request to a real-time payment platform located remotely from the user device;
receive a real-time payment identifier generated by the real-time payment platform based on the real-time payment identifier request;
store the real-time payment identifier in a real-time payment identifier database, wherein the a real-time payment identifier database is stored on the user device;
receive a first transaction identifier request associated with at least one of the phone number and a user account identifier from a first merchant system;
communicate the real-time payment identifier to the first merchant system in response to receiving the first transaction identifier request;
receive a second transaction identifier request associated with at least one of the phone number and the account identifier from a second merchant system; and
communicate the real-time payment identifier to the second merchant system in response to receiving the second transaction identifier request.

9. The computer program product of claim 8, wherein the program instructions further cause the at least one processor to:
receive a second real-time payment identifier request, the second real-time payment identifier request comprising a second account identifier;
communicate the second real-time payment identifier request to the real-time payment platform located remotely from the user device;
receive a second real-time payment identifier generated by the real-time payment platform based on the real-time payment identifier request; and
store the second real-time payment identifier on the user device.

10. The computer program product of claim 8, wherein the real-time payment identifier request is received from a user through the real-time payment application stored on the user device.

11. The computer program product of claim 8, wherein the first transaction identifier request is received from a second application stored on the user device.

12. The computer program product of claim 8, wherein receiving the first transaction identifier request occurs before the real-time payment identifier request is received, wherein the program instructions further cause the at least one processor to:
determine no real-time payment identifier has been previously received associated with at least one of the phone number associated with the user device and the account identifier; and
communicate a real-time payment identifier initiation notification to the user device in response to determining no real-time payment identifier has been previously received, wherein the real-time payment identifier initiation notification directs the user to communicate the real-time payment identifier request to the real-time payment application.

13. The computer program product of claim 8, wherein the program instructions further cause the at least one processor to:
in response to receiving the first transaction identifier request, communicate a one-time password to the user device;
receive the one-time password from the first merchant system;
match the one-time password received from the first merchant system to the one-time password communicated to the user device; and
communicate the real-time payment identifier to the first merchant system in response to matching the one-time password.

14. The computer program product of claim 8, wherein the real-time payment identifier request is initiated during an initial setup process of the user device.

15. A system for real-time transactions, comprising at least one real-time payment application including at least one processor programmed or configured to:
receive a real-time payment identifier request, the real-time payment identifier request comprising at least one of a phone number associated with a user device and an account identifier;
communicate the real-time payment identifier request to a real-time payment platform located remotely from the user device;
receive a real-time payment identifier generated by the real-time payment platform based on the real-time payment identifier request;
store the real-time payment identifier in a real-time payment identifier database, wherein the a real-time payment identifier database is stored on the user device;
receive a first transaction identifier request associated with at least one of the phone number and a user account identifier from a first merchant system;
communicate the real-time payment identifier to the first merchant system in response to receiving the first transaction identifier request;
receive a second transaction identifier request associated with at least one of the phone number and the account identifier from a second merchant system; and
communicate the real-time payment identifier to the second merchant system in response to receiving the second transaction identifier request.

16. The system of claim 15, wherein the at least one processor is further programmed or configured to:
receive a second real-time payment identifier request, the second real-time payment identifier request comprising a second account identifier;
communicate the second real-time payment identifier request to the real-time payment platform located remotely from the user device;
receive a second real-time payment identifier generated by the real-time payment platform based on the real-time payment identifier request; and
store the second real-time payment identifier on the user device.

17. The system of claim 15, wherein the real-time payment identifier request is received from a user through the real-time payment application stored on the user device.

18. The system of claim 15, wherein the first transaction identifier request is received from a second application stored on the user device.

19. The system of claim 15, wherein receiving the first transaction identifier request occurs before the real-time payment identifier request is received, wherein the at least one processor is further programmed or configured to:
determine no real-time payment identifier has been previously received associated with at least one of the phone number associated with the user device and the account identifier; and
communicate a real-time payment identifier initiation notification to the user device in response to determining no real-time payment identifier has been previously received, wherein the real-time payment identifier initiation notification directs a user to communicate the real-time payment identifier request to the real-time payment application.

20. The system of claim 15, wherein the at least one processor is further programmed or configured to:
in response to receiving the first transaction identifier request, communicate a one-time password to the user device;
receive the one-time password from first merchant system;
match the one-time password received from the first merchant system to the one-time password communicated to the user device; and
communicate the real-time payment identifier to the first merchant system in response to matching the one-time password.

21. The system of claim 15, wherein the real-time payment identifier request is initiated during an initial setup process of the user device.
